(19) United States
(12) Patent Application Publication
(10) Pub. No.: US 2018/0224142 A1
(43) Pub. Date: Aug. 9, 2018

(54) SITE-CUSTOMIZED BENCHMARK FOR OPERATING AN AIR CONDITIONING SYSTEM IN REAL TIME

(71) Applicant: James Eric Taylor, El Centro, CA (US)

(72) Inventor: James Eric Taylor, El Centro, CA (US)

(21) Appl. No.: 15/428,643

(22) Filed: Feb. 9, 2017

(51) Int. Cl. F24F 11/00; G05B 15/02

(52) U.S. Cl. CPC F24F 11/006; G05B 15/02; F24F 2011/0075; F24F 2011/0047; F24F 2011/0068; F24F 2011/0046

(57) ABSTRACT

A system for customizing an HVAC system for operation at a specific site requires defining a benchmark which is based on environmental data taken from the site, and on operational data taken from the HVAC system at the site. For the present invention, this benchmark establishes limits for acceptable environmental conditions at the site and appropriate ranges for cost-effective, operational parameters for the HVAC system. In particular, changes in the operational condition of the HVAC system which result from changes in the environmental condition at the site are evaluated relative to the benchmark. This evaluation is then used by a system controller to identify corrective actions necessary for optimal performance of the HVAC system.

### FIELD OF THE INVENTION

The present invention pertains generally to systems and methods for customizing Heating-Ventilating-Air-Conditioning (HVAC) systems for operation at a specific site. In particular, the present invention is provided to customize HVAC systems in accordance with a predetermined environmental/operational benchmark which is established based on environmental considerations pertinent to a particular site and operational considerations provided by the manufacturer of the HVAC equipment. The present invention is particularly, but not exclusively, useful for employing environmental sensors positioned in the site and operational sensors incorporated with the HVAC system, for the purposes of jointly evaluating data from the sensors to maintain efficient benchmark-based operational parameters for the HVAC system that achieve appropriate, cost effective, environmental conditions at the site.

### BACKGROUND OF THE INVENTION

HVAC systems are manufactured to have predetermined operational capabilities. Typically, within these capabilities, an HVAC system will be rated in accordance with its ability to process (i.e. heat, cool and/or dehumidify) a prescribed volume of air, within a predetermined temperature range, for a defined period of time. However, once an HVAC system has been installed for operation at a specified site, its operational efficiency is always significantly impacted by various external factors. Specifically, each of these factors results from a characteristic of the site where the HVAC system is installed (e.g. climate, building structure, ducting, power grid regulations, etc.).

Not surprisingly, it happens that the operational capabilities of any HVAC system will change over time. Importantly, such changes can result from either systemic or external factors, or a combination of the two. In any event, it is important to at least periodically monitor the operational condition of an installed HVAC system in order to identify ways by which an operation of the system can be improved. For example, U.S, Pat. No. 6,128,910 which issued for an invention entitled “Diagnostic Unit for an Air Conditioning System”, and which is assigned to Enalasys Corporation, is suitable for this purpose.

In addition to the operational capabilities of the HVAC system, and the conditions at the site where it is installed, it is also typically the case that different locations within a particular site will have different temperature requirements that are specific for each location. Stated differently, each operational site has its own unique HVAC requirements. Moreover, as implied above, power grid regulations and operating costs always need to be considered whenever an HVAC system is installed.

In light of the above, it is an object of the present invention to provide systems and methods for customizing Heating-Ventilating-Air-Conditioning (HVAC) systems for operation at a specific site. Another object of the present invention is to customize HVAC systems in accordance with a predetermined environmental/operational benchmark which has been established based on environmental considerations pertinent to a particular site, and on the operational capabilities provided by the manufacturer of the HVAC equipment. Still another object of the present invention is to provide systems and methods for customizing a particular site with a specific HVAC system which is easy to install, is simple to operate, and is comparatively cost effective,

### SUMMARY OF THE INVENTION

In accordance with the present invention, an apparatus is provided for customizing a closed air Heating-Ventilating-Air-Conditioning (HVAC) system. In particular, as envisioned for the present invention, the HVAC system will be installed at a predetermined site and the apparatus will be customized for an efficacious operation at the site. For this purpose, a database is compiled arid used for defining a benchmark. More specifically, the defined benchmark establishes limits for environmental conditions which are acceptable at the site. The benchmark also sets operating ranges R₍₁₋ₙ₎ for an efficient operation of the HVAC system at the site.

Structurally, in addition to the HVAC system, the present invention employs an m number of environmental sensors and an n number of diagnostic sensors. In particular, each environmental sensor is positioned at a predetermined location in the site to obtain sensible measurements. These measurements are then used as environmental data e₍₁₋ₘ₎. Collectively, the environmental data Σe₍₁₋ₘ₎ defines an environmental condition at the site. As mentioned above, the present invention also employs an n number of diagnostic sensors. Each diagnostic sensor is incorporated into the HVAC system to measure respective enthalpies h₍₁₋ₙ₎ at predetermined locations in the HVAC system. These measurements are then used as diagnostic data. Collectively, the diagnostic data Σh₍₁₋ₙ₎ determines an operational condition of the HVAC system at the site. Preferably, the collection of diagnostic data is accomplished in accordance with the disclosure of U.S. Pat. No. 6,128,910, mentioned above.

For an operation of the present invention, a computer is connected to each of the m number of environmental sensors, to each of the n number of diagnostic sensors, and to the database. With these connections the computer uses the predefined benchmark to evaluate changes in the operational conditions of the HVAC system. Specifically, the present invention is focused on changes in the operational conditions of the HVAC system that occur in response to changes in environmental conditions at the site. Based on these evaluations, corrective actions are identified which are necessary for an optimally safe and efficient operation of the HVAC system.

As intended for the present invention, the benchmark includes benchmark enthalpies h_{b(1-n)} which are established for a rated operation of the HVAC system in compliance with the established environmental conditions at the site. Within this framework, changes in an operational condition of the HVAC system are indicated by deviations Δ₍₁₋ₙ₎ of the diagnostic data from the benchmark enthalpies (i.e. Δₙ=h_{bn}−hₙ). Importantly, a necessary corrective action for the HVAC system is indicated when any deviation Δ₍₁₋ₙ₎ is outside its respective acceptable range R₍₁₋ₙ₎, as established for the benchmark. For example, an appropriate corrective action may require adjusting the operating point of a fan in the HVAC system or, perhaps, a complete shutdown of the fan. Another appropriate corrective action may require adjusting the operating point of a compressor in the HVAC system or, alternatively, a complete shutdown of the compressor.

In addition to the components for the present invention disclosed above, it also includes a system controller which is connected to the computer, to the HVAC system, arid to a public utility. In this combination, the system controller implements a corrective action for the HVAC system in response to instructions from either the computer or from the utility. Insofar as control of the computer is concerned, the system controller handles computer control as disclosed above. However, insofar as a response to utility control is concerned, actions by the system controller are effectively driven by cost considerations.

For an interaction of the system controller with a utility, a permanent sensor is connected and installed in the HVAC system. The purpose here is for the permanent sensor to measure kilowatt-hours (kWh) for the fan, and also kWh for the compressor of the HVAC system. For these connections, the permanent sensor is programmed with a base line which is fixed on the established environmental condition. Generally, the system controller will honor demands from the utility. It will, however, ignore a demand corrective action from the utility unless all environmental conditions established for the site can be satisfied.

Additional aspects and capabilities for the system controller of the present invention are provided by a chip included with the system controller for establishing a two-way wireless communications link between the system controller and the utility, and between the system controller and a remote site. In particular, this communications link is established to receive information from the utility, or the remote site, for implementing operational compliance of the system with price point controls established by the utility. Additionally, in order to identify corrective actions necessary for an optimal performance of the HVAC system, the system controller can be employed to prepare a periodic report for this purpose. Specifically, the report will be based on the deviations Δ₍₁₋ₙ₎ of the diagnostic data from the benchmark enthalpies (Δₙ=h_{bn}−hₙ) relative to respective acceptable ranges R₍₁₋ₙ₎, and to changes in kWh measurements of operational components of the HVAC system.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a functional flow chart showing the tasks/components required by the present invention for implementing a corrective action affecting the HVAC system;

FIG. 2 is a schematic diagram of an apparatus for customizing a closed air Heating-Ventilating-Air-Conditioning (HVAC) system in accordance with the present invention;

FIG. 3 is a layout of the basic operational components for an HVAC system, with interactive sensors shown incorporated in accordance with the present invention; and

FIG. 4 is a representative graphical presentation of exemplary benchmark enthalpies for different sensors of the present invention, which collectively establish an operational benchmark for the present invention, wherein enthalpies measured by the sensors at an operational site are shown relative to an acceptable operating range for enthalpy deviations from the benchmark enthalpies.

### DESCRIPTION OF THE PREFERRED EMBODIMENTS

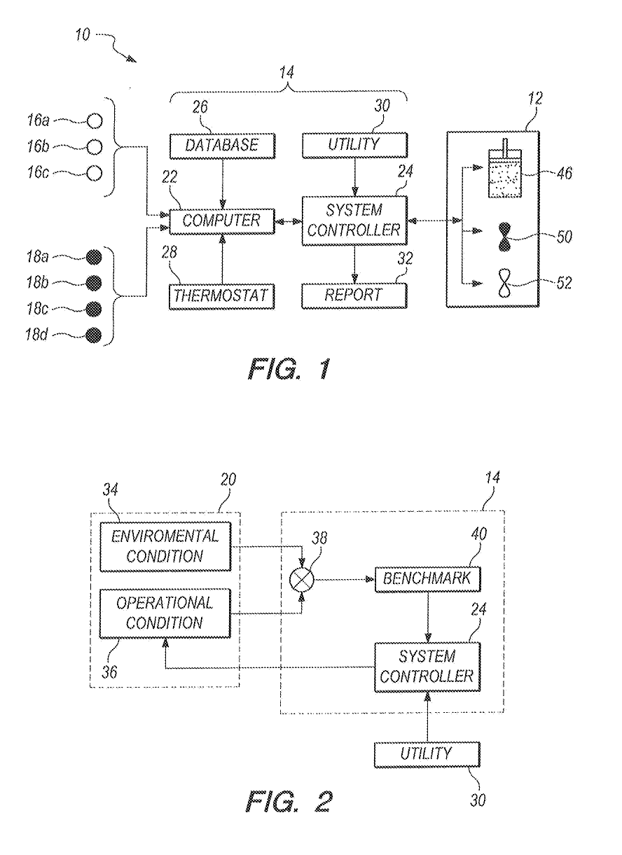

Referring initially to FIG. 1, an apparatus for customizing air flow in an environment is shown and is generally designated 10. As shown, the apparatus 10 includes a closed air, Heating-Ventilating-Air-Conditioning (HVAC) system 12 of a type well known in the pertinent art. Also, FIG. 1 shows that the apparatus 10 includes a control unit 14 which is connected to the HVAC system 12. Additionally, the apparatus 10 includes a plurality of environmental sensors 16, of which the sensors 16a, 16b and 16c are exemplary; and a plurality of diagnostic sensors 18, of which the sensors 18a, 18b, 18c and 18d are exemplary.

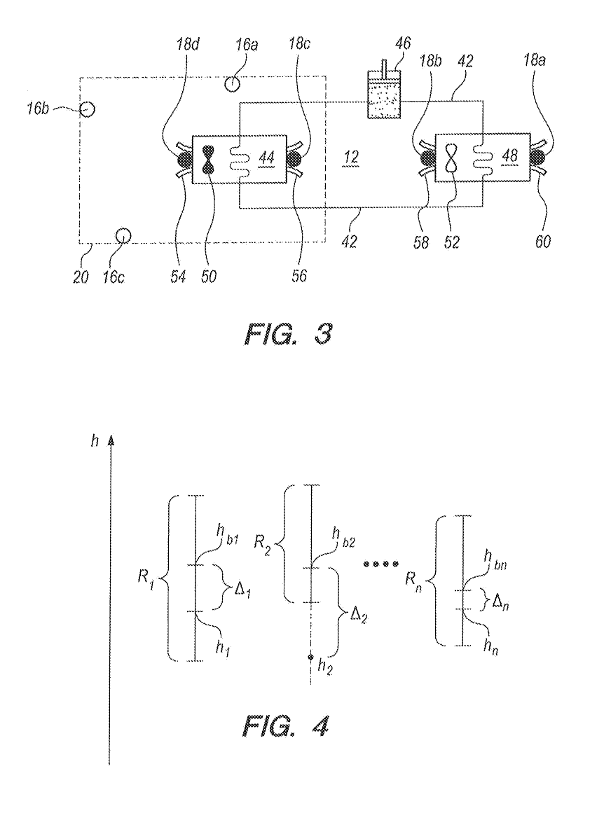

For purposes of the present invention, the environmental sensors 16a-c are to be positioned at selected locations inside a site 20 (see FIGS. 2 and 3). At the site 20, the environmental sensors 16a-c measure both a temperature and a humidity at each of their respective locations in the site 20. Further, as shown in FIG. 3, the diagnostic sensors 16a-d are employed with the HVAC system 12 at the site 20. Operationally, the diagnostic sensors 18a-d are individually used to measure an enthalpy h, which is based on a dry bulb temperature and a relative humidity. For purposes of the present invention, the enthalpies h are measured at predetermined locations on the HVAC system 12. Specifically, locations for the diagnostic sensors 18 on the HVAC system 12 are disclosed below, in detail, with reference to FIG. 3.

Returning to FIG. 1, it will be seen that the control unit 14 includes a computer 22 and a system controller 24. FIG. 1 also shows that the computer 22 is electronically connected to receive respective inputs from a database 26, a thermostat 28, the plurality of environmental sensors 16, and the plurality of diagnostic sensors 18. In this combination, input from the database 26 to the computer 22 includes information regarding operational capabilities of the HVAC system 12, as rated by the particular manufacturer. Also included in the database 26 is information concerning desired environmental considerations for the site 20, such as acceptable ranges for the temperature and humidity at different locations within the site 20. Additionally, centralized input into the computer 22 from the thermostat 28 is provided to establish desired operating points for the HVAC system 12, which are based on real time measurements that are taken by the environmental sensors 16a-c and the diagnostic sensors 18a-d.

The system controller 24 shown in FIG. 1 is responsive to both the computer 22 and to a utility 30. Specifically, the system controller 24 uses output from the computer 22 to monitor and control the HVAC system 12. For purposes of controlling the HVAC system 12, however, the system controller 24 is also responsive to the utility 30 (e.g. a public grid). In particular, the control of the HVAC system 12 that is required by the utility 30 is provided to implement operational compliance mandates, and to conform an operation of the HVAC system 12 to predetermined price point controls. FIG. 1 also indicates that the system controller 24 will periodically prepare a report 32 that can be transmitted to a remote, oversight control facility (not shown).

Referring back to FIGS. 2 and 3, it is to be appreciated that the environmental sensors 16 which are positioned in the site 20 collectively define an environmental condition 34 for the present invention. Likewise, it is to be appreciated that the diagnostic sensors 18 which are placed at predetermined locations on the HVAC system 12 collectively define an operational condition 36 for the present invention. FIG. 2 also indicates that both the environmental condition 34 and the operational condition 36 are sent to a summary recorder 38 in the computer 22 of the control unit 14. As disclosed in detail below, it is an important feature of the present invention that the environmental condition 34 and the operational condition 36 are used together by the summary recorder 38 to create a benchmark 40 for an operation of the present invention.

With reference to FIG. 3, it will be seen that the HVAC system 12 essentially includes a fluid line 42 which interconnects various operational components of the HVAC system 12. In particular, arranged along the fluid line 42 in the direction of fluid flow are an evaporator 44, a compressor 46, a condenser 48 and a return to the evaporator 44. Further, the evaporator 44 is shown to include an evaporator fan 50, and the condenser 48 is shown to include a condenser fan 52. Additionally, the evaporator 44 has an evaporator inlet 54 and an evaporator outlet 56. Similarly, the condenser 48 has an intake 58 and an exhaust 60. As envisioned for the present invention, the HVAC system 12 operates in a manner that is well known in the pertinent art.

Importantly, for purposes of the present invention, the HVAC system 12 includes a diagnostic sensor 18a which is shown positioned at the exhaust 60 of the condenser 48, and a diagnostic sensor 18b which is positioned at its intake 58. Additionally, the HVAC system 12 includes a diagnostic sensor 18c which is positioned at the outlet 56 of the evaporator 44, and a diagnostic sensor 18d which is positioned at its inlet 54. Insofar as the environmental sensors 16a-c are concerned, they are shown randomly dispersed throughout the site 20, as required.

In accordance with the present invention, an m number of environmental sensors 16 are respectively positioned at predetermined locations in the site 20. Their primary function is to obtain sensible measurements from the environment of site 20 which can be used as environmental data e₍₁₋ₘ₎ to collectively determine the environmental condition 34 (Σe₍₁₋ₘ₎) at the site 20. Also, an n number of diagnostic sensors 18 are incorporated into the HVAC system 12 to measure enthalpies h₍₁₋ₙ₎ at predetermined locations in the HVAC system 12. Their collective function is to obtain enthalpy data which collectively determine the operational condition 36 (Σh₍₁₋ₙ₎) of the HVAC system 12.

As noted above, an important feature of the present invention is the creation and use of a database 26 which defines a benchmark 40. In particular, the benchmark 40 establishes parameters for the environmental condition 34 at the site 20. In particular, this is accomplished by setting acceptable operating ranges R₍₁₋ₙ₎ for the operational condition 36 of the HVAC system 12.

For an operation of the present invention, the computer 22 is connected directly to the m number of environmental sensors 16, and to the n number of diagnostic sensors 18. Using these connections, the computer 22 compares changes in the operational condition 36 (Σh₍₁₋ₙ₎) of the HVAC system 12 that are responsive to changes in the environmental condition 34 (Σe₍₁₋ₘ₎) at the site 20. This comparison is then evaluated with reference to the benchmark 40 that is defined by the database 26. Next, the results of this comparison are transmitted from the computer 22 to the system controller 24 where whatever corrective actions are necessary for an optimal performance of the HVAC system 12 are taken.

As implied above, the benchmark 40 includes benchmark enthalpies h_{b(1-n)} which are established within acceptable operating ranges R₍₁₋ₙ₎. Specifically, the acceptable operating ranges R₍₁₋ₙ₎ are identified relative to the operational condition 36 of the HVAC system 12. They must, however, be identified for compliance with the environmental condition 34. With this in mind, and with reference to FIG. 4, it will be appreciated that changes in the operational condition 36 of the HVAC system 12 are indicated by deviations Δ₍₁₋ₙ₎ of the diagnostic data from the benchmark enthalpies (Δₙ=h_{bn}−hₙ). Accordingly, a necessary corrective action for the HVAC system 12 is indicated when a deviation Δ₍₁₋ₙ₎ is outside its respective acceptable range R₍₁₋ₙ₎. For example, as envisioned for the present invention, corrective actions can include adjusting an operating point, or causing the complete shutdown, of a fan (e.g. evaporator fan 50 or condenser fan 52) in the HVAC system 12. A corrective action may also involve adjusting the operating point, or causing the complete shutdown, of the compressor 46.

Additional features for the present invention include a permanent sensor (not shown) in the HVAC system 12 which will be used to measure kilowatt-hours (kWh) for the fans (e.g. evaporator fan 50 or condenser fan 52) and for the compressor 46. When used, the permanent sensor is programmed with a base line, and the base line is fixed relative to the environmental condition 34. In response to input from the permanent sensor (via computer 22), the system controller 24 will implement an appropriate corrective action for the HVAC system 12. The system control 24 may, however, ignore a demand corrective action from the utility 30 when the environmental condition 34 that is established for the site 20 cannot be satisfied.

Another feature for the present invention involves a chip (not shown) for establishing two-way wireless communications links between the system controller 24 and the utility 30 and/or with a remote site. In particular, such wireless connections are convenient for receiving information which may be needed for implementing operational compliance and price point control requirements. Further, it is envisioned that the system controller 24 will prepare a periodic report 32 that provides information concerning the deviations Δ₍₁₋ₙ₎ from the benchmark enthalpies (Δₙ=h_{bn}−hₙ) relative to respective acceptable ranges R₍₁₋ₙ₎, and to changes in kWh measurements. It is also envisioned that the periodic reports 32 are monitored by the system controller 24 at a remote site, and are used by the system controller 24 to identify corrective actions necessary for an optimal performance of the HVAC system.

While the particular Site-Customized Benchmark for Operating an Air Conditioning System in Real Time as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. An apparatus for customizing a closed air Heating-Ventilating-Air-Conditioning (HVAC) system, wherein the HVAC system is installed at a site, the apparatus comprising:
an m number of environmental sensors, wherein each environmental sensor is positioned at a predetermined location in the site to obtain sensible measurements for use as environmental data e₍₁₋ₘ₎, wherein the environmental data collectively Σe₍₁₋ₘ₎, defines an environmental condition at the site;
an n number of diagnostic sensors, wherein each diagnostic sensor is incorporated into the HVAC system to measure respective enthalpies h₍₁₋ₙ₎ at predetermined locations in the HVAC system for use as diagnostic data, wherein the diagnostic data, collectively Σh₍₁₋ₙ₎, determines an operational condition of the HVAC system;
a database for defining a benchmark, wherein the benchmark establishes limits for the environmental condition at the site, and sets operating ranges R₍₁₋ₙ₎ for the operational condition of the HVAC system; and
a computer connected to the m number of environmental sensors, to the n number of diagnostic sensors, and to the database, for using the benchmark of the database to evaluate a change in the operational conditions of the HVAC system in response to a change in the environmental condition at the site, and to identify corrective actions necessary for an optimal performance of the HVAC system.

2. The apparatus recited in claim 1 wherein the benchmark includes benchmark enthalpies h_{b(1-n)} established for a rated operation of the HVAC system in compliance with the established environmental condition, wherein a change in the operational condition of the HVAC system is indicated by deviations Δ₍₁₋ₙ₎ of the diagnostic data from the benchmark enthalpies (Δₙ=h_{bn}−hₙ), and wherein necessary corrective action is indicated when a deviation Δ₍₁₋ₙ₎ is outside its respective acceptable range R₍₁₋ₙ₎.

3. The apparatus recited in claim 2 wherein the corrective actions include adjusting an operating point of a fan in the HVAC system, to include a shutdown of the fan, and adjusting an operating point of a compressor in the HVAC system, to include a shutdown of the compressor.

4. The apparatus recited in claim 3 further comprising a system controller connected to a utility, to a permanent sensor in the HVAC system, and to the computer for measuring kilowatt-hours (kWh) for the fan and kWh for the compressor of the HVAC system, wherein the permanent sensor is programmed with a base line, and the base line is fixed on the established environmental condition, and further wherein the system controller implements a corrective action for the HVAC system in response to instructions from the computer and from the utility, but ignores a demand corrective action from the utility unless the environmental condition established for the site is satisfied.

5. The apparatus recited in claim 4 wherein the system controller includes a chip for establishing a two-way wireless communications link with the utility and with a remote site, to receive information respectively therefrom for implementing operational compliance and price point controls.

6. The apparatus recited in claim 5 wherein the system controller prepares a periodic report based on the deviations Δ₍₁₋ₙ₎ of the diagnostic data from the benchmark enthalpies (Δₙ=h_{bn}−hₙ) relative to respective acceptable ranges R₍₁₋ₙ₎, and to changes in kWh measurements, to identify corrective actions necessary for an optimal performance of the HVAC system.

7. The apparatus recited in claim 4 wherein the periodic reports are monitored by the system controller at a remote site, and are used by the system controller to implement the corrective actions.

8. The apparatus recited in claim 1 wherein the HVAC system comprises:
an evaporator with an inlet and an outlet, wherein a first diagnostic sensor is permanently incorporated into the inlet of the evaporator, and wherein a second diagnostic sensor is permanently incorporated into the outlet of the evaporator; and
a condenser with an intake and an exhaust, wherein a third diagnostic sensor is permanently incorporated into the intake of the condenser and, wherein a fourth diagnostic sensor is permanently incorporated into the exhaust of the condenser.

9. The apparatus recited in claim 1 wherein the enthalpies h₍₁₋ₙ₎ measured by the diagnostic sensors are based on respective readings of a dry bulb temperature and a relative humidity.

10. The apparatus recited in claim 1 wherein the environmental data for the site includes a temperature and a humidity for each e₍₁₋ₘ₎.

11. An apparatus for customizing a closed air Heating-Ventilating-Air-Conditioning (HVAC) system, wherein the HVAC system is installed at a site, the apparatus comprising:
a means for obtaining sensible measurements from the site for use as environmental data e₍₁₋ₘ₎, wherein the environmental data, collectively Σe₍₁₋ₘ₎, defines an environmental condition at the site;
a means for measuring respective enthalpies h₍₁₋ₙ₎ at predetermined locations in the HVAC system for use as diagnostic data, wherein the diagnostic data, collectively Σh₍₁₋ₙ₎, determines an operational condition of the HVAC system;
a means for establishing a benchmark, wherein the benchmark provides limits for the environmental condition at the site, and sets operating ranges R₍₁₋ₙ₎ for the operational conditions of the HVAC system; and
a computer respectively connected to the means for obtaining sensible measurements, to the means fore measuring enthalpies, and to the means for establishing a benchmark, to identify a change in the operational condition of the HVAC system in response to a change in the environmental condition at the site, and to identify corrective actions for the HVAC system necessary for an optimal performance of the HVAC system.

12. The apparatus recited in claim 11 wherein the means for obtaining sensible measurements includes an m number of environmental sensors, wherein each environmental sensor is positioned at a predetermined location in the site to obtain sensible measurements for use as environmental data e₍₁₋ₘ₎, wherein the environmental data, collectively Σe₍₁₋ₘ₎, defines an environmental condition at the site.

13. The apparatus recited in claim 12 wherein the means for measuring enthalpies h₍₁₋ₙ₎ in the HVAC system includes an n number of diagnostic sensors.

14. The apparatus recited in claim 12 wherein the means for establishing limits and setting operating ranges is a database.

15. The apparatus recited in claim 14 wherein the database defines a benchmark, and the benchmark includes benchmark enthalpies h_{b(1-n)} established for a rated operation of the HVAC system in compliance with the established environmental condition, wherein a change in the operational condition of the HVAC system is indicated by deviations Δ₍₁₋ₙ₎ of the diagnostic data from the benchmark enthalpies (Δₙ=h_{bn}−hₙ), and wherein necessary corrective action is indicated when a deviation Δ₍₁₋ₙ₎ is outside its respective acceptable range R₍₁₋ₙ₎.

16. The apparatus recited in claim 12 further comprising a system controller connected to a utility, to a permanent sensor in the HVAC system and to the computer for measuring kilowatt-hours (kWh) for the fan and kWh for the compressor of the HVAC system, wherein the permanent sensor is programmed with a base line, and the base line is fixed on the established environmental condition, and further wherein the system controller implements a corrective action for the HVAC system in response to instructions from the computer and from the utility, but ignores a demand corrective action from the utility while the environmental condition established for the site is satisfied.

17. The apparatus recited in claim 16 wherein the system controller includes a chip for establishing a two-way wireless communications link with the utility and with a remote site, to receive information respectively therefrom for implementing operational compliance and price point controls.

18. A method for customizing a closed air Heating-Ventilating-Air-Conditioning (HVAC) system, wherein the HVAC system is installed at a site, the method comprising the steps of:
positioning an m number of environmental sensors at predetermined locations in the site to obtain sensible measurements for use as environmental data e₍₁₋ₘ₎, wherein the environmental data, collectively Σe₍₁₋ₘ₎, defines an environmental condition at the site;
incorporating an n number of diagnostic sensors into the HVAC system to measure respective enthalpies h₍₁₋ₙ₎ at predetermined locations in the HVAC system for use as diagnostic data, wherein the diagnostic data, collectively Σh₍₁₋ₙ₎, determines an operational condition of the HVAC system;
establishing a database for defining a benchmark, wherein the benchmark establishes limits for the environmental condition at the site, and sets operating ranges R₍₁₋ₙ₎ for the operational condition of the HVAC system, arid wherein the benchmark includes benchmark enthalpies h_{b(1-n)} established for a rated operation of the HVAC system in compliance with the established environmental condition, wherein a change in the operational condition of the HVAC system is indicated by deviations Δ₍₁₋ₙ₎ of the diagnostic data from the benchmark enthalpies (Δₙ=h_{bn}−hₙ), and wherein necessary corrective action is indicated when a deviation Δ₍₁₋ₙ₎ is outside its respective acceptable range R₍₁₋ₙ₎; and
connecting a computer to the m number of environmental sensors, to the n number of diagnostic sensors, and to the database, for using the benchmark to identify a change in the operational condition of the HVAC system in response to a change in the environmental condition at the site, and to identify corrective actions necessary for an optimal performance of the HVAC system,

19. The method recited in claim 18 further comprising the step of including a system controller in the computer, and wherein the system controller is connected to a utility, and to a permanent sensor in the HVAC system for measuring kilowatt-hours (kWh) for the fan and kWh for the compressor of the HVAC system, wherein the permanent sensor is programmed with a base fine, and the base line is fixed on the established environmental condition, and further wherein the system controller implements a corrective action for the HVAC system in response to instructions from the computer and from the utility, but ignores a demand corrective action from the utility while the environmental condition established for the site is satisfied.

20. The method recited in claim 19 wherein the system controller includes a chip for establishing a two-way wireless communications link with the utility and with a remote site, to receive information respectively therefrom for implementing operational compliance and price point controls.
